(19) United States
(12) Patent Application Publication
(10) Pub. No.: US 2018/0290088 A1
(43) Pub. Date: Oct. 11, 2018

(54) SELF-SUPPORTING INDUSTRIAL AIR FILTER

(71) Applicants: Dale R. Kadavy, Overland Park, KS (US); Vishal Bansal, Lee's Summit, MO (US); Jeffery Michael Ladwig, Overland Park, KS (US)

(72) Inventors: Dale R. Kadavy, Overland Park, KS (US); Vishal Bansal, Lee's Summit, MO (US); Jeffery Michael Ladwig, Overland Park, KS (US)

(73) Assignee: Parker-Hannifin Corporation, Cleveland, OH (US)

(21) Appl. No.: 15/944,511

(22) Filed: Apr. 3, 2018

Related U.S. Application Data
(60) Provisional application No. 62/482,432, filed on Apr. 6, 2017.

(51) Int. Cl. B01D 41/04; B01D 24/48; B01D 46/24; B01D 46/52; B01D 46/00; B01D 24/00

(52) U.S. Cl. CPC B01D 41/04; B01D 24/4884; B01D 46/2403; B01D 46/527; B01D 2325/40; B01D 25/06; B01D 2201/0415; B01D 2275/105; B01D 2275/30; B01D 46/0001

(57) ABSTRACT

A self-supporting filter media as well filter element and filtration system including the same is provided. A method of manufacturing the self-supporting filter media is also provided. The self-supporting filter media is formed such that it has a rigidity which permits the omission of filter support cage or other internal media support structure.

### CROSS-REFERENCE TO RELATED PATENT APPLICATION

This patent application claims the benefit of U.S. Provisional Patent Application No. 62/482,432, filed Apr. 6, 2017, the entire teachings and disclosure of which are incorporated herein by reference thereto.

### FIELD OF THE INVENTION

This invention generally relates to filtration, and more particularly to industrial air filters.

### BACKGROUND OF THE INVENTION

Filters are commonly used to remove particulate matter from an air stream in an industrial air filtration system. For example, such filters are often used in known baghouses. At least some known baghouses include a housing that has an inlet that receives dirty, particulate-containing air, and an outlet through which clean air is discharged from the baghouse. In such baghouses, often the interior of the housing is divided, by a tube sheet, into a dirty air or upstream plenum, and a clean air or downstream plenum. Air flows through the inlet into the dirty air plenum, through the filters, and into the clean air plenum before clean air is discharged through the outlet of the clean air plenum.

One particular type of filter used in such industrial applications utilizes what is referred to as a filter bag installed on a cage. The filter bag is made of a porous material through which air passes. Dust and other contaminants in the air stream are trapped by the porous filter media material. The filter bag is supported on its interior side by the cage, which is a generally rigid assembly.

For the typical bag and cage installation, the bag is applied to the tube sheet and the welded cage is then installed into the bag in one or more pieces. This method of installation necessitates that there is clearance designed between the bag and cage to allow for field assembly. If this clearance is too small, the bags will be difficult to install. If the clearance is too large, the bags will wear prematurely.

Because the cages have useful life longer than bags, they are retained and re-fit to new bags when filters need to be replaced. After months or years of operation, the removal of the bag from the cage and re-installation of an old cage into a new bag requires significant labor, and handling of the old bag may require significant precautions to protect the health of the individuals changing filters if the filtered dust is hazardous.

Accordingly, there is a need in the art for a rigid, self-supporting filter media and associated filter which does not require a support cage and is suitable for application in baghouse systems. The invention provides such a filter media, filter, and system. These and other advantages of the invention, as well as additional inventive features, will be apparent from the description of the invention provided herein.

### BRIEF SUMMARY OF THE INVENTION

A self-supporting filter media according to the teachings herein may be made from one or more layers of a fiber-reinforced composite material. The composite material is designed so that multiple layers of fibers create a structure that is porous, allowing air flow through the material. A binder is used to attach the fibers together so that they provide the necessary structure to withstand differential pressure created by air flow through the fibrous medium.

Choice of fiber materials, fiber sizes, and binder systems may be driven by the filtration application were the filters are intended to be used. Fibers may be glass, thermoplastic, or other fibers such as metal, carbon or silica. The sizing of the fibers may be dictated by the size of the particulate to be filtered from the air stream with larger fibers being used to create a larger pore size for larger dust. Likewise, finer fibers may be used to create a smaller pore size for smaller dust. Fibers may also be blended homogeneously or layered in a gradient fashion to create the desired pore structure, temperature and chemical resistance. The binder systems may be thermosetting, thermoplastic, or epoxy systems. They type of binder system used may be driven by application considerations such as temperature or chemical resistance, or commercial considerations such as cost. Binders may also be blended or layered as needed to create the support structure for the fibers.

Heat treatment or chemical treatment could also be used to modify the characteristics of the fibers and/or binders used to create the air filter pore structure. These treatments may be used in impart superior mechanical properties, alter surface properties such as water or oil repellency, enhance chemical resistance, or improve dust release.

For air filters which are to be back-pulsed, surface filtration is a desired characteristic. This surface filtration may be accomplished by creating a surface with a finer pore size on the “dirty” side of the filter. This finer pore structure may be created using small diameter fibers suspended in a binder or it may be achieved by a surface coating of fine fibers deposited by electro-spinning or force-spinning. A membrane of expanded polytetrafluoroethylene (ePTFE) or other materials may also be laminated to the dirty side of the filter to provide fine filtration. A blend of surface filtration materials may be used homogeneously or in a gradient fashion. Surface filtration layers may also be heat treated or chemically treated to impart mechanical properties, alter surface properties such as water or oil repellency, enhance chemical resistance, or improve dust release.

The self-supporting filter may be manufactured in a variety of geometries due to the elimination of the support cage and cage clearance. The filters may have a constant cross section over its length, or it may be rotated, blended or swept through varying cross sections. These filter cross-sections may include a simple, circular shape, or a shape designed to increase the filter cross-sectional area including pleated, lobed, or star-shaped. Other configurations designed to increase filtration area such as using concentric cylinders would also be possible with the self-supporting tube.

The self-supporting filter must have a means of attachment to the tube sheet which divides the clean side from the dirty side of the dust collector. Self-supporting filters may be attached to the tube sheet using elastomeric gaskets, felt or woven gaskets, or felt or woven cuffs applied to the ID of the tube sheet opening or to the face of either side of the tube sheet. Stepped, tapered, or expandable features may be incorporated to extend the range of tube sheet holes that may be fit with a single filter.

Like the tube sheet attachment feature, filters may be joined one or more other filters to extend the total length of the combined filter element. Self-supporting filters may be attached to the other self-supporting filter elements end-to-end using elastomeric gaskets, felt or woven gaskets, or felt or woven cuffs applied to the ID or OD of the filter element. They may also use the face of either filter element. Stepped, tapered, or expandable features may be incorporated to extend the range of filters that may be connected to another filter element.

In one aspect, the invention provides a method for manufacturing a self-supporting filter media. An embodiment of such a method includes providing a forming device, placing a deactivated filter media on the forming device, activating the deactivated filter media to form an activated filter media, removing the forming device from the activated filter media.

In certain embodiments, the forming device is a mandrel which has a circular cross section. In other embodiments, the forming device may be a mandrel which has a non-circular cross section.

In certain embodiments, the deactivated filter media comprises a fibrous material and a binder. The fibrous material may comprise at least one of glass fibers, thermoplastic fibers, and metal fibers, polymer fibers.

In certain embodiments, the binder comprises one of a phenolic, polyester, polyurethane, vinyl ester, epoxy, silicone, melamine, diallyl phthalate, polypropylene, polyethylene, nylon, polyphenylene sulfide, polyvinylidene fluoride, or polytetrafluoroethylene-polymer.

In certain embodiments, activating includes curing in a curing oven. Activating may also include chemical curing.

In certain embodiments, the fibrous material has a fiber diameter of 0.2 micron to 30 micron. In certain embodiments, filter media has a mean flow pore size of 0.1 micron to 100 micron. The filter media may comprise multiple layers of filter media, wherein the multiple layers of filter media have differing compositions from one another.

In certain embodiments, the method may also include applying a coating to at least one of an interior or exterior surface of the filter media prior to curing. Additionally or in the alternative, the method may also include applying a coating to at least one of an interior or exterior surface of the cured filter media after curing.

In certain embodiments, the filter media comprises at least one of a high efficiency filtration layer and a surface filtration layer.

In another aspect, a self-supporting filter media is provided. An embodiment according to this aspect includes at least one layer of filter media, the at least one layer of filter media including a binder and a fibrous material.

In certain embodiments, the fibrous material may include at least one of glass fibers, thermoplastic fibers, metal fibers, and polymer fibers. The fibrous material may have a fiber diameter of 0.2 micron to 20 micron. The binder may comprise one of a phenolic, polyester, polyurethane, vinyl ester, epoxy, silicone, melamine, diallyl phthalate, polypropylene, polyethylene, nylon, polyphenylene sulfide, polyvinylidene fluoride, or polytetrafluoroethylene polymer.

In certain embodiments, the at least one layer of the filter media has a mean flow pore size of 0.1 micron to 100 micron. The at least one layer of filter media may include a plurality of filter media layers, wherein the plurality of filter media layers have differing compositions from one another.

In certain embodiments, a coating on at least one of an interior and exterior surface of the at least one layer filter media may be provided.

In certain embodiments, the at least one layer of filter media comprises at least one of a high efficiency filtration layer and a surface filtration layer.

In yet another aspect, the invention provides a filter element. An embodiment of a filter element according to this aspect includes at least one layer of filter media, the at least one layer of filter media including a binder and a fibrous material. The filter element also includes a first end cap, the first end cap configured to form a seal with a tube sheet of a filtration housing. The filter element is free of an internal support structure such that only the at least one layer of filter media is situated between the end caps.

In certain embodiments, the filter element also includes a second end cap, the first and second end caps respectively positioned at first and second ends of the at least one layer of filter media. In certain embodiments, the fibrous material comprises at least one of glass fibers, thermoplastic fibers, metal fibers, and polymer fibers. The fibrous material has a fiber diameter of 0.2 micron to 20 micron.

In certain embodiments, the binder comprises one of a phenolic, polyester, polyurethane, vinyl ester, epoxy, silicone, melamine, diallyl phthalate, polypropylene, polyethylene, nylon, polyphenylene sulfide, polyvinylidene fluoride, or polytetrafluoroethylene polymer.

In certain embodiments, the at least one layer of filter media has a mean flow pore size of 0.1 micron to 100 micron. In certain embodiments, the at least one layer of filter media includes a plurality of deactivated cured filter media layers, wherein the plurality of deactivated cured filter media layers have differing compositions from one another.

In certain embodiments, the filter element also includes a coating on at least one of an interior and exterior surface of the at least one layer of deactivated cured filter media.

In certain embodiments, the filter element also includes at least one of a high efficiency filtration layer and a surface filtration layer.

In certain embodiments, the high efficiency filtration layer comprises at least one of electro-spun, force-spun, nano, fine, spunbonded, ePTFE or meltblown fibers, or ePTFE membrane.

In yet another aspect, the invention provides a filtration system. An embodiment of a filtration system according to this aspect includes a housing having an inlet and an outlet, the inlet separated from the outlet by a tube sheet. The system also includes at least one filter element mounted to the tube sheet, the filter element comprising at least one layer of filter media, the at least one layer of filter media including a binder and a fibrous material.

In certain embodiments, the at least one filter element comprises a plurality of filter elements arranged in an array relative to the tube sheet.

In certain embodiments, less than 70 pulses are required during 2 hour performance testing using Pural NF dust per ASTM D6830, and less than 200 pulses are required during 6 hour performance testing using Pural NF dust per ASTM D6830.

Other aspects, objectives and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is a front view of a filtration system incorporating a filter element which utilizes self-supporting filter media according to the teachings herein;

FIG. 2 is a cross section of the filter element of FIG. 1;

FIG. 3 is a partial view of the cross section of FIG. 2; and

FIG. 4 is a perspective schematic illustration of a stage of manufacturing the self-supporting filter media; and

FIG. 5 is a flow chart depicting one embodiment of a method according to the teachings herein.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

Turning now to the drawings, a self-supporting filter media as well as a filter element incorporating the same are shown and described. Also shown is an exemplary embodiment of a filtration system employing the aforementioned filter element. As will be understood from the following, the self-supporting media described herein advantageously allows for the provision of a filter element which does not require any support structure to support the filter media. The filter media itself is self-supporting and strong enough to maintain its shape under typical pressure differentials seen in a variety of filtration applications. Such a configuration leads to a filter element which lasts longer, and is less costly to produce. As a result, the invention achieves a substantial cost and labor reduction in the maintenance and operation of a baghouse filtration system.

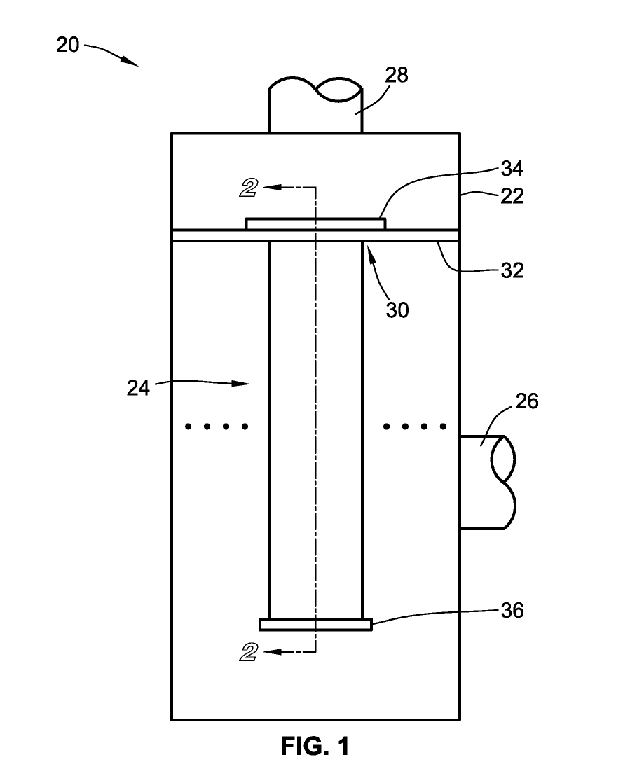

With particular reference now to FIG. 1, a filtration system 20 is illustrated. This filtration system 20 includes a schematically illustrated housing 22 which carries a filter element 24 that employs a self-supporting filter media according to the teachings herein. Housing 22 includes an inlet 26 and an outlet 28. Filter element 24 is situated within housing 22 such that it is sealingly mounted within an opening 30 of a tube sheet 32. Tube sheet 32 divides the interior of filter housing 22 into a dirty side which opens to inlet 26, and a clean side which opens to outlet 28. Air entering inlet 26 passes through the aforementioned self-supporting filter media of filter element 24 and then exits housing 22 via outlet 28. It will be recognized by those of skill in the art that FIG. 1 represents a generally schematic exemplary configuration of a typical baghouse filtration system. However, the self-supporting media described herein may be incorporated into filter elements which are utilized in applications not associated with a baghouse. Further, although a single filter element 24 is illustrated, it will be recognized that in a typical configuration multiple filter elements 24 are mounted to tube sheet 32 within the interior of housing 22.

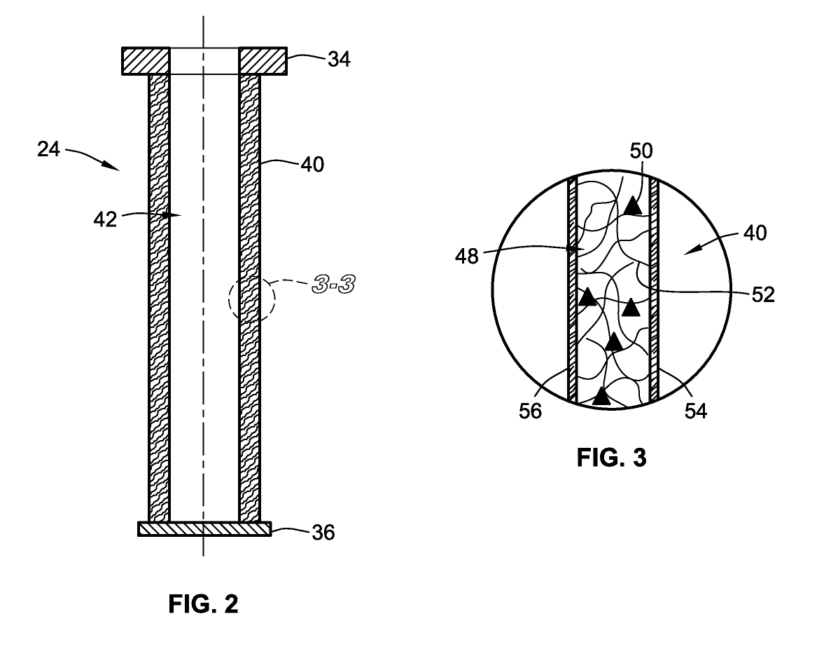

Turning now to FIG. 2, the same illustrates a cross-section of filter element 24. Filter element 24 includes a ring of self-supporting filter media 40. Filter element 24 also includes an open end cap as a first end cap 34 at one end of filter element 24. A closed end cap in the form of a second end cap 36 is positioned opposite first end cap 34. First end cap 34 may incorporate a variety of contemporary tube sheet sealing configurations including gaskets, radial or annular seals, etc. Further, a cap of self-supporting filter media may be utilized in place of second end cap 36 to increase overall filtration area.

As will be understood in from the following, filter media 40 may be a deactivated filter media which may be activated to transition the same from a deactivated filter media to an activated filter media. Such activation includes, but is not limited to, activing a binder interspersed with the fibers of the filter media and/or curing a resin interspersed with the fibers of the filter media.

Turning now to FIG. 3, the same illustrates a schematic cross-section of the self-supporting filter media according to the teachings herein. As can be seen in this view, filter media 40 includes at least one layer 48 of filter media. This layer 48 includes a fibrous material represented by fibers 52 and a binder, resin, or other substance (collectively referred to as binder 50) interspersed throughout fibers 52. This binder 50 has been activated such that it has hardened to provide the needed strength and rigidity to filter media 40. As a result, and with momentary reference back to FIG. 2, an interior support structure such as a support cage or other rigid structure is not within the interior 42 of filter element 24 to support the same. Filter media 40 is thus self-supporting. Put differently, because the media itself is responsible for providing support, additional filtration depth is provided by this embodiment which would otherwise not be available. The increased filtration depth increases the filter dust holding capacity and helps to manage differential pressure over the life of the filter. Indeed, the support cage or structure in prior designs takes up a substantial portion of the filter element with which it is incorporated in, yet provides no filtration capabilities.

Still referring to FIG. 3, filter media 40 may also include additional layers 54, 56 on the interior and exterior surfaces of filter element 24. These additional layers 54, 56 may be other fibrous layers similar to or the same as layer 48, or alternatively, may have different properties. For example, either or both of additional layers 54, 56 may be a high efficiency filtration layer. As non-limiting examples, this high efficiency filtration layer may comprise at least one of electro-spun, nano, fine, spun-bonded, meltblown, melt-spun, or force-spun fibers, or ePTFE membrane. Such a high efficiency layer may present a mean flow pore size of 0.2 to 40 microns. Alternatively or in addition, layers 54, 56 may also be coatings such as fire, moisture, or acid-resistant coatings.

Further, the outer layer 54 may be designed as a surface filtration layer, having a mean flow pore size of 0.5 to 40 microns. This will allow a dust cake to form on the inlet side of filter media 40 and enhance the filtration efficiency of filter element 24. As non-limiting examples, this surface filtration layer may comprise at least one of electro-spun, nano, fine, spun-bonded, meltblown, melt-spun, or force-spun fibers, or ePTFE membrane. Although only a single layer 54, 56 is shown on the clean and dirty side, respectively, multiple layers may be presented on the inlet side of layer 48, and multiple layers may be presented on the outlet side of layer 48. Use of such a surface filtration layer as described above also allows filter element 24 to be back-pulsed for cleaning purposes. Advantageously, filter media 40 is of a strong enough construction to permit such back pulsing without the need of the support structure of prior designs.

Layer 48 may present a generally uniform mean flow pore size of 0.1 micron to 100 micron. Alternatively, layer 48 may be constructed by utilizing fibers of different diameter or different spacing to achieve a variable pore size as air moves through filter media 40 to achieve a desired filtration gradient. One example of such a configuration may be to use a very small pore size near the inlet side of filter media 40 to provide for fine filtration at the surface thereof as mentioned above. Alternatively, filter media 40 may utilize a variable pore size which begins large near the inlet side of filter media 40 and progressively becomes smaller towards the outlet side of filter media 40. Still further, layer 48 may in its entirety, or in at least a portion, be provided as a high-efficiency filtration layer as provided above. Accordingly, it is contemplated herein that the filter media 40 includes at least one layer of filter media, which may include those layers 48, 54, 56, described above, as well as fewer or additional layers, as also described above.

As used above, the terms inlet side and outlet side of the filter media are made relative to the direction of air flow through the filter media. The inlet side is that side of the filter media 40 which air encounters first. The outlet side is that side of filter media 40 which air encounters after encountering the inlet side.

Various fiber types and fiber sizes may be utilized in layer 48. As non-limiting examples, the fibrous material 52 which makes up layer 48 may be made of one or more of glass fibers, thermoplastic fibers, metal fibers, and/or polymer fibers. Further, such fibers may have an exemplary fiber diameter of 0.2 micron to 30 micron. It will be recognized, however, that other fiber diameter may be utilized and are contemplated herein.

The binder 50 employed may take on a variety of forms depending upon application. As non-limiting examples, the binder may be one of a phenolic, polyester, polyurethane, vinyl ester, epoxy, silicone, melamine, diallyl phthalate, polypropylene, polyethylene, nylon, polyphenylene sulfide, polyvinylidene fluoride, or polytetrafluoroethylene polymer.

Such a binder may be a resin which may be activated, i.e. cured via heat, chemically, or via any other known cure methodology based on the resin utilized. Other processing may also be employed. For example, additional chemical and heat treatments may be employed before or after curing. Further, electrostatic charging may also be employed. These processing steps will largely depend upon the application of filter media 40. It will be understood, however, where the binder is not a resin, other activations steps will be utilized outside of curing used with a resin system. For example, the binder may be chemically activated, heat activated, pressure activated, etc. Accordingly, terms such as “activating” and “activate” and their derivatives are used herein to mean any operation which transitions a binder into a state which provides the required strength and rigidity to filter media 40 so as to not require an additional support structure.

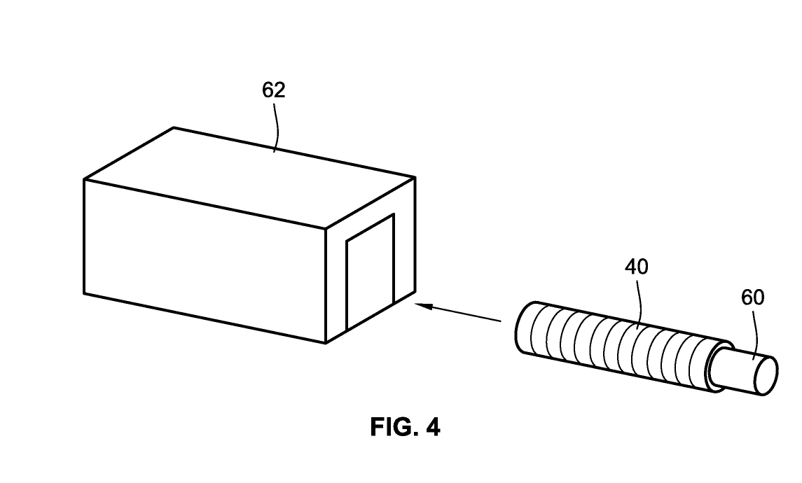

Turning now to FIG. 4, the same illustrates a generally schematic view of the formation of filter media 40 into a desired shape. As can be seen in this figure, filter media 40 is in its deactivated state and is wrapped around a mandrel 60. In the illustrated embodiment, filter media 40 is generally very flexible prior to activation allowing it to be shaped around mandrel 60. Once wrapped about mandrel 60, the mandrel is then placed into an activating device. In the illustrated embodiment, this activating device is a curing oven 62 used to cure a resin which constitutes binder 50 in the illustrated example. However, this activating device will vary depending upon the activating method utilized. This curing step is necessary to cure the resin contained within filter media 40 to transform the same from its deactivated state to its activated state. By doing so, filter media 40 becomes rigid and assumes the overall shape of the mandrel 60 upon which it was wrapped.

Although a cylindrical mandrel 60 is utilized, other shapes are contemplated. For example, mandrel 60 may have a non-circular cross-section. An example of such a configuration may be a triangular or star-shaped cross-section. A star shape is particularly useful as it could be utilized to form pleats to increase the overall surface area of filter media 40. Further, mandrel 60 may be shaped such that filter media 40 follows a twist, i.e. helical axis, along its length. It will be recognized that relatively complex geometries may be achieved based on the shape of mandrel 60.

Although not shown in FIG. 4, it will be recognized that a conveyor or feeding device may also be used for moving mandrel 60 into curing device 62. Such a system may include a conveyor, rollers, or any combination thereof. The particular system used will depend largely upon the curing device selected. It will be recognized that where multiple layers 48 of filter media are employed, each will be wrapped around mandrel 60 as illustrated in FIG. 4. Further, a pre-cure coating or treatment may be applied to media 40 prior to or after it has been wrapped around mandrel 60. Likewise after curing a post-cure coating may also be applied.

Broadly, forming a self-supporting filter media for incorporation into a filter element according to the teachings herein includes first providing a forming device. Thereafter, a deactivated layer or layers of filter media is/are applied to the forming device. Thereafter, the layer or layers is/are activated in an activating device. This cases the layer or layers of media to become structurally rigid. The forming device is then removed, and subsequent operations such as end cap installation, etc., may ensue. The forming device may be a mandrel, form, or mold, or any structure which functions to hold a general shape of the deactivated media while transitioning the same form a deactivated state to an activated state. The activating device may be any device used to transition the media from its deactivated to its activated state by interacting with the binder provided within the media.

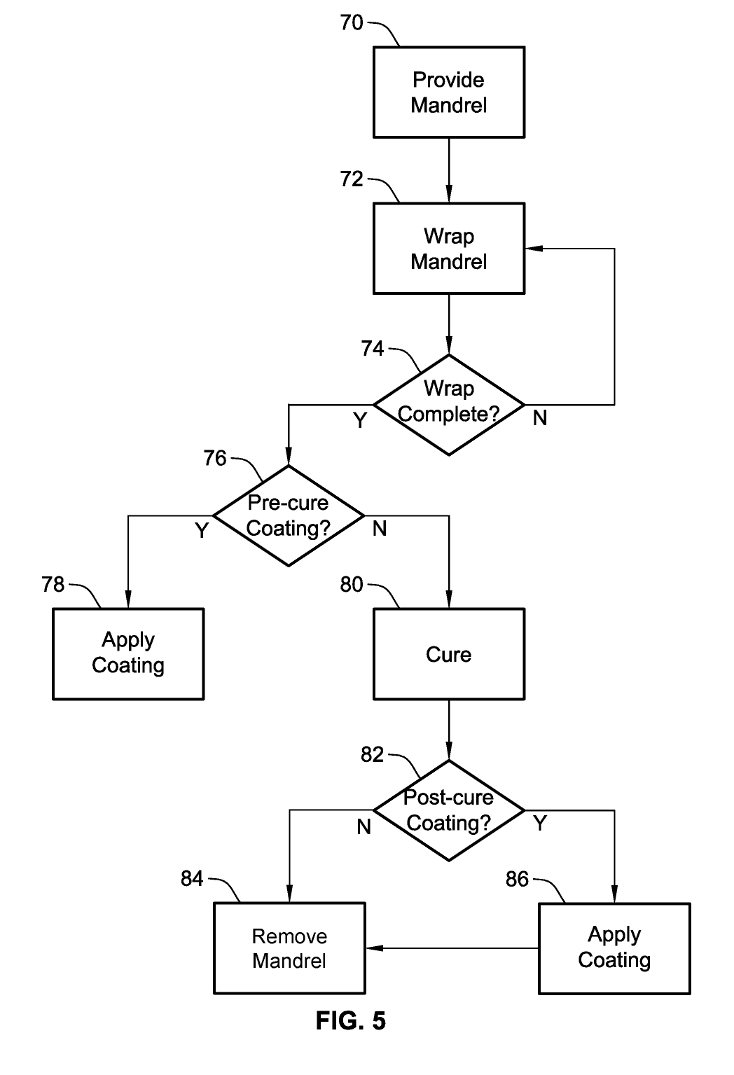

Turning now to FIG. 5, the same illustrates one exemplary schematic process of forming the self-supporting media as described herein. At step 70, a forming device in the form of a mandrel is provided. At step 72, the mandrel is wrapped with one or more layers of filter media 40. These layers may have identical or different properties including but not limited to the types of fibers used, or the binders contained therein. This wrapping continues at steps 72, 74 until wrapping is complete.

Once wrapping is complete, a pre-cure coating may be applied at steps 76 and 78. Whether utilizing a pre-cure coating or not, process then moves to step 80 where the wrapped mandrel is placed in the curing device and the filter media 40 is cured. After curing at step 80, a post-cure coating may be applied at steps 82 and 86. The mandrel 84 is then removed and the self-supporting filter media is formed.

As discussed above, post-processing steps may also include other treatment such as chemical or heat treating steps. Further electrostatic charges may be applied to enhance the filtration capabilities of the self-supporting media. Also as described above, a high efficiency filtration layer may also be applied to the exterior surface of the cured filter media 40. This high efficiency layer may be formed concurrently during curing step 80 by wrapping mandrel 60 with an outermost wrap of very fine fibers suitable for high efficiency filtration which become rigid after curing. Alternatively, this high efficiency filtration layer may be applied after curing via another process as described above, e.g. electrospinning.

After being formed and after any additional post-processing, cured filter media 40 may be utilized in the manufacture of a filter element such as that shown in FIGS. 1 and 2. Indeed, first and second end caps 34, 36 may be attached. As discussed above, however, second end cap 36 may be omitted where the same is formed via cured filter media. Additionally, although a basic cylindrical filter element 24 is shown herein, it is contemplated that the self-supporting media described may be utilized to multiple filter elements which nest into one another to form a concentric primary/secondary filtration configuration. It will be recognized that while filter media 40 is cured it can be utilized to form a variety of filter elements not limited to the exemplary configuration shown herein. Indeed, the self-supporting media may be utilized in a variety of applications and advantageously allow for the omission of an internal support structure which is otherwise typically required.

Other formation methodologies are also contemplated by the teachings herein. For example, the fibers 52 of filter media 40 may be coated with a binder and air-laid in a web, or the fibers 52 may be treated with a binder after the web is formed. As another example, the fibers may be chopped, mixed with a binder, and then sprayed into a sheet or onto a form such as a mandrel or mold for subsequent activation. Still further, the fibers may be wet laid into a sheet, or onto a form such as a mandrel or mold. Still further, sheets, molds and mandrels treated with fiber and binder may have subsequent forming operations performed on them to achieve the targeted size, shape and density of fibers appropriate for filtration. These operations may include compressing in molds, expanding in molds, compressing using consumable components, thermal forming, hydroforming, rotational molding, or blow molding.

Media 40 according to the invention as described above performs exceedingly well in surface filtration applications. For example, testing of the media 40 per ASTM D6830-02 revealed very good results. According to this test, a dust concentration 8+−1.6 gr/dscf, filtration velocity 6.6+−0.5 ft/min, pulse pressure 75 psi, pulse duration 50 ms, air temperature 78+−4 F and relative humidity 50+−10%, were used. Per this test, a conditioning phase 10,000 pulses at 3-5 second intervals was employed, then a recovery phase at 30 pulses was employed after the pressure differential across a test sample of media 40 reaches 4″ w.c. Thereafter performance test phase was conducted During this phase, the number of pulses required during the performance test phase of ASTM were measured at two and six hour time intervals were measured. The results were less than 70 pulses during 2 hour performance test using Pural NF dust per ASTM D6830-02 for the two hour test, and less than 200 pulses during 6 hour performance test using Pural NF dust per ASTM D6830-02 for the six hour test.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A method for manufacturing a self-supporting filter media, the method comprising:
providing a forming device;
placing a deactivated filter media on the forming device;
activating the deactivated filter media to form an activated filter media;
removing the forming device from the activated filter media.

2. The method of claim 1, wherein the forming device is a mandrel which has a circular cross section.

3. The method of claim 1, wherein the forming device is a mandrel which has a non-circular cross section.

4. The method of claim 1, wherein the deactivated filter media comprises a fibrous material and a binder.

5. The method of claim 4, wherein the fibrous material comprises at least one of glass fibers, thermoplastic fibers, and metal fibers, polymer fibers.

6. The method of claim 4, wherein the binder comprises one of a phenolic, polyester, polyurethane, vinyl ester, epoxy, silicone, melamine, diallyl phthalate, polypropylene, polyethylene, nylon, polyphenylene sulfide, polyvinylidene fluoride, or polytetrafluoroethylene polymer.

7. The method of claim 1, wherein activating includes curing in a curing oven.

8. The method of claim 1, wherein activating includes chemical curing.

9. The method of claim 4, wherein the fibrous material has a fiber diameter of 0.2 micron to 30 micron.

10. The method of claim 1, wherein the filter media has a mean flow pore size of 0.1 micron to 100 micron.

11. The method of claim 1, wherein the filter media comprises multiple layers of filter media, wherein the multiple layers of filter media have differing compositions from one another.

12. The method of claim 1, further comprising applying a coating to at least one of an interior or exterior surface of the filter media prior to curing.

13. The method of claim 1, further comprising applying a coating to at least one of an interior or exterior surface of the cured filter media after curing.

14. The method of claim 1, wherein the filter media comprises at least one of a high efficiency filtration layer and a surface filtration layer.

15. A self-supporting filter media, comprising at least one layer of filter media, the at least one layer of filter media including a binder and a fibrous material.

16. The self-supporting filter media of claim 15, wherein the fibrous material comprises at least one of glass fibers, thermoplastic fibers, metal fibers, and polymer fibers.

17. The self-supporting filter media of claim 15, wherein the fibrous material has a fiber diameter of 0.2 micron to 20 micron.

18. The self-supporting filter media of claim 15, wherein binder comprises one of a phenolic, polyester, polyurethane, vinyl ester, epoxy, silicone, melamine, diallyl phthalate, polypropylene, polyethylene, nylon, polyphenylene sulfide, polyvinylidene fluoride, or polytetrafluoroethylene polymer.

19. The self-supporting filter media of claim 15, wherein the at least one layer of the filter media has a mean flow pore size of 0.1 micron to 100 micron.

20. The self-supporting filter media of claim 15, wherein the at least one layer of filter media includes a plurality of filter media layers, wherein the plurality of filter media layers have differing compositions from one another.

21. The self-supporting filter media of claim 15, further comprising a coating on at least one of an interior and exterior surface of the at least one layer of filter media.

22. The self-supporting filter media of claim 15, wherein the at least one layer of filter media comprises at least one of a high efficiency filtration layer and a surface filtration layer.

23. A filter element, comprising:
at least one layer of filter media, the at least one layer of filter media including a binder and a fibrous material;
a first end cap, the first end cap configured to form a seal with a tube sheet of a filtration housing; and
wherein the filter element is free of an internal support structure such that only the at least one layer of filter media is situated between the end caps.

24. The filter element of claim 23, further comprising a second end cap, the first and second end caps respectively positioned at first and second ends of the at least one layer of filter media.

25. The filter element of claim 23, wherein the fibrous material comprises at least one of glass fibers, thermoplastic fibers, metal fibers, and polymer fibers.

26. The filter element of claim 23, wherein the fibrous material has a fiber diameter of 0.2 micron to 20 micron.

27. The filter element of claim 23, wherein binder comprises one of a phenolic, polyester, polyurethane, vinyl ester, epoxy, silicone, melamine, diallyl phthalate, polypropylene, polyethylene, nylon, polyphenylene sulfide, polyvinylidene fluoride, or polytetrafluoroethylene polymer.

28. The filter element of claim 23, wherein the at least one layer of filter media has a maximum mean flow pore size of 0.1 micron to 100 micron.

29. The filter element of claim 23, wherein the at least one layer of deactivated cured filter media includes a plurality of deactivated cured filter media layers, wherein the plurality of deactivated cured filter media layers have differing compositions from one another.

30. The filter element of claim 23, further comprising a coating on at least one of an interior and exterior surface of the at least one layer of deactivated cured filter media.

31. The filter element of claim 23, further comprising a high efficiency filtration layer.

32. The filter element of claim 31 wherein the high efficiency filtration layer comprises at least one of electro-spun, nano, fine, spunbonded, or meltblown fibers, or ePTFE membrane.

33. A filtration system, comprising:
a housing having an inlet and an outlet, the inlet separated from the outlet by a tube sheet;
at least one filter element mounted to the tube sheet, the filter element comprising at least one layer of filter media, the at least one layer of filter media including a binder and a fibrous material.

34. The filtration system of claim 34, wherein the at least one filter element comprises a plurality of filter elements arranged in an array relative to the tube sheet.

35. The self-supporting filter media of claim 15, wherein less than 70 pulses are required during 2 hour performance testing using Pural NF dust per ASTM D6830-02.

36. The self-supporting filter media of claim 15, wherein less than 200 pulses are required during 6 hour performance testing using Pural NF dust per ASTM D6830-02.
